(19) United States
(12) Patent Application Publication
(10) Pub. No.: US 2013/0311220 A1
(43) Pub. Date: Nov. 21, 2013

(54) EVALUATING DEPLOYMENT READINESS IN DELIVERY CENTERS THROUGH COLLABORATIVE REQUIREMENTS GATHERING

(71) Applicants: Milton H. Hernandez, Tenafly, NJ (US); Jim A. Laredo, Katonah, NY (US); Sriram K. Rajagopal, Chennai (IN); Yaoping Ruan, White Plains, NY (US); Maja Vukovic, New York, NY (US)

(72) Inventors: Milton H. Hernandez, Tenafly, NJ (US); Jim A. Laredo, Katonah, NY (US); Sriram K. Rajagopal, Chennai (IN); Yaoping Ruan, White Plains, NY (US); Maja Vukovic, New York, NY (US)

(73) Assignee: International Business Machines Corporation, Armonk, NY (US)

(21) Appl. No.: 13/472,986

(22) Filed: May 18, 2012

(51) Int. Cl. G06Q 10/06

(52) U.S. Cl. 705/7.14

(57) ABSTRACT

A method and data processing system for determining deployment readiness of a service is disclosed. A computer identifies tasks that must be performed to address requirements associated with categories of complexity for deploying the service in one or more locations. The computer assigns the identified tasks to experts based on skill and availability of the experts. The computer verifies whether the assigned tasks have been completed. The computer then provides an indication that the service is ready to be deployed in one or more locations responsive to the verification that the tasks have been completed.

### BACKGROUND

1. Field

The disclosure relates generally to service deployment and in particular, to evaluating service deployment readiness of a computer system. Still more particularly, the present disclosure relates to a method, data processing system, and computer program product for using collaborative methodologies to engage globally distributed subject matter experts to determine deployment readiness of services in a services delivery environment.

2. Description of the Related Art

Services delivery environments provide computing resources as a service instead of a product. Resources such as hardware, software, and information are provided to users over a network such as the Internet. Services delivery environments provide users access to shared resources without requiring the users to have knowledge of the physical location and configuration of the system providing the services.

Providers of services delivery environments often deliver applications via the Internet. These applications are accessed from a web browser. The software and information used by the users are typically stored at server computers on a remote location.

As new services are offered, or as the capacity for current resources are increased, the provider installs these services on server computers. For example, database services, hypertext transfer protocol services, and other types of service may be installed on computers in a services delivery environment. These services are typically installed with a default configuration that allows a particular service to run using a minimum amount of resources. These default configurations, however, may not be a correct configuration or even a complete configuration for providing a desired level of performance and functionality. Services delivery environments also include traditional distributed systems that use client-server architectures.

Currently, service deployment personnel configure and trouble-shoot services to ensure the services will run in the services delivery environment with an expected level of performance and functionality. This type of trouble-shooting too often requires subject matter experts having skills that are unique to categories of complexity. This type of management of services delivery increases performance and capabilities of those services. The increase in performance and capabilities, however, is often more labor-intensive and expensive than desired.

Additionally, as is known by those of skill in the art, Web 2.0 Technologies® have significantly enhanced interactive information sharing and collaboration over the Internet. This has enabled crowdsourcing to develop as an increasingly popular approach for performing certain kinds of important tasks. In a crowdsourcing effort or procedure, a large group of organizations, individuals and other entities that desire to provide pertinent services, such as a specific community of providers or the general public, are invited to participate in a task that is presented by a task requester. Examples of such tasks include, but are not limited to, developing specified software components, collaboratively discovering enterprise knowledge, and other such tasks that are suitable for crowdsourcing efforts.

At present, a crowdsourcing platform may serve as a broker or intermediary between the task requester and software providers who are interested in undertaking or participating in task performance. Crowdsourcing platforms generally allow requesters to publish or broadcast their challenges and tasks, and further allow participating providers that are successful in completing the task to receive specified monetary rewards or other incentives. Innocentive®, TopCoder®, and MechanicalTurk® are examples of presently available platforms.

Currently however, there is no system or process available for determining deployment readiness of a service at a location through collaborative requirements gathering, such as using a crowdsourcing platform. Instead, such tasks typically must be manually performed by a service deployment team, and the assumption is that the tasks can be predetermined. At present, scripts or API mechanisms may be used to determine configuration information at a location where a service is being deployed. Yet services delivery environments are very complex and dynamic ecosystems, with lots of unknowns. Variability in networking, hardware, software, security and people aspects In a given environment makes services deployment even more challenging. Creation of categories of complexities associated with a service deployment and creation of service deployment requirements for the categories of complexity for use in identifying tasks that must be performed to address the service deployment requirements at particular locations is generally not addressed by the current state of the art.

Therefore, it would be advantageous to have a method, data processing system, and computer program product that takes into account at least some of the issues discussed above, as well as possibly other issues.

### SUMMARY

In one illustrative embodiment, a method, data processing system, and computer program product for determining deployment readiness of a service is provided. A data processing system identifies tasks that must be performed to address requirements associated with categories of complexity for deploying the service in one or more locations, which are discovered through collaborative process. This enables on-time and at-cost delivery of the service, while maintaining customer satisfaction levels. In addition to known tasks the system also identifies and verifies the complexity of the deployment, as well as the topology of the service environment, which may further uncover additional deployment tasks. The data processing system assigns the identified tasks to experts based on skill and availability of the experts. The data processing system verifies whether the assigned tasks have been completed. The data processing system then provides an indication that the service is ready to be deployed in one or more locations responsive to the verification that the tasks have been completed.

### BRIEF DESCRIPTION OF THE SEVERAL VIEWS OF THE DRAWINGS

FIG. 1 a block diagram of components involved in determining deployment readiness of a service in a service deployment readiness evaluation environment in accordance with an illustrative embodiment;

FIG. 2 is a schematic diagram showing a process for determining service deployment readiness in accordance with an illustrative embodiment;

FIG. 3 is a flow chart of a process for determining service deployment readiness in accordance with an illustrative embodiment;

FIG. 4 is a flow chart of a process for identifying categories of complexity and requirements associated with the categories of complexity for determining service deployment readiness in accordance with an illustrative embodiment;

FIG. 5 is a flow chart of a process for defining deployment complexity templates for use in determining service deployment readiness in accordance with an illustrative embodiment; and

FIG. 6 is an illustration of a data processing system in accordance with an illustrative embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

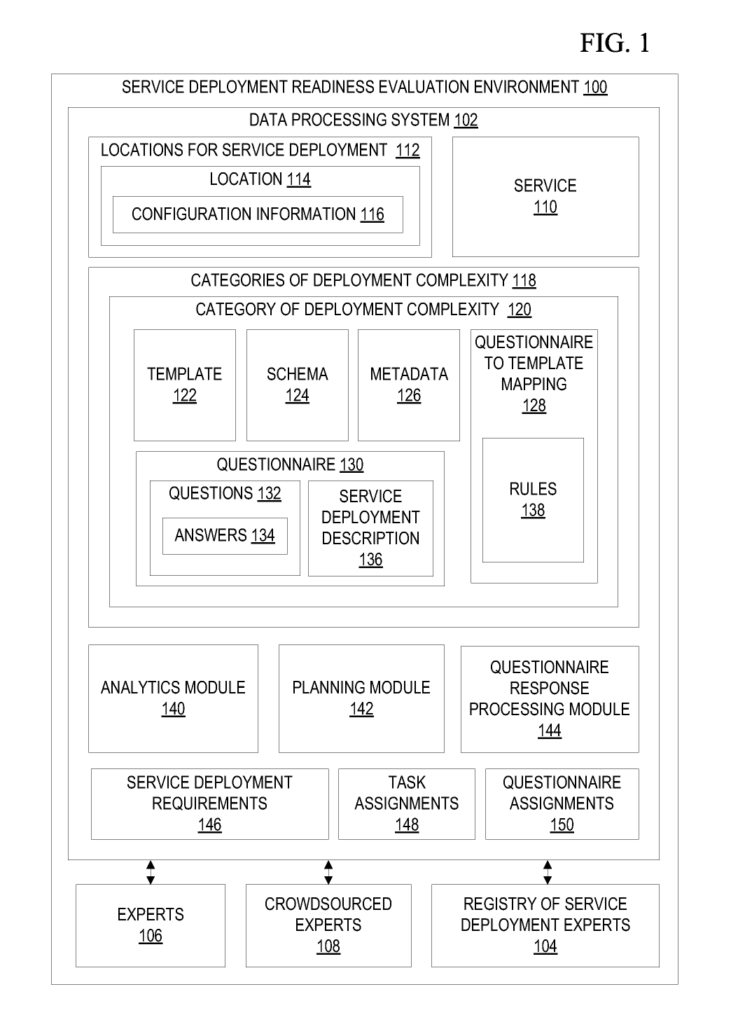

With reference now to the figures and, in particular, with reference to FIG. 1, an illustration of components involved in determining deployment readiness of a service in a service deployment readiness evaluation environment is depicted in accordance with an illustrative embodiment. In this illustrative example, data processing system 102 is present in service deployment readiness evaluation environment 100. Data processing system 102 may comprise a set of computers. A “set,” as used herein with reference to items, means one or more items. For example, “set of computers” is one or more computers. When more than one computer is present in data processing system 102, those computers may be in communication with each other. This communication may be facilitated through a medium such as a network. This network may be, for example, without limitation, a local area network, a wide area network, an intranet, the internet, and some other suitable type of network.

In these illustrative examples, registry of service deployment experts 104 is located in service deployment readiness evaluation environment 100. Registry of service deployment experts 104 may comprise hardware, software, or a combination of the two. Registry of service deployment experts 104 may be, for example, without limitation, a program, an application, a plug-in, or some other form of program code. Registry of service deployment experts 104 may comprise experts 106 and crowdsourced experts 108. In these illustrative examples, experts 106 are experts identified in registry of service deployment experts 104 as having particular expertise associated with evaluating service deployment readiness. Crowdsourced experts 108 comprise experts available through a crowdsourcing platform for performing tasks associated with evaluating service deployment readiness. In these illustrative examples, experts 106 and crowdsourced experts 108 may comprise subject matter experts (SMEs), data processing system administrators, quality assurance analysts, service deployment managers, service deployment focal points, experts of a local service deployment team, and service deployment experts who code rules that map questions to complexity based readiness criteria identified in registry of service deployment experts 104 as available for evaluating service deployment readiness.

As depicted, service 110 is a service that has been identified for deployment in locations for service deployment 112. For example, service 110 may be a service selected by a customer for hosting in location 114. In these illustrative examples, location 114 in locations for service deployment 112 may include a local or remote server, a local or remote client. Further in these illustrative examples, locations for service deployment 112 may be a list of servers of a services delivery center such as application servers, database servers, and web hosting servers. Still further in these illustrative examples, locations in locations for service deployment 112 that are servers may host a plurality of services for a plurality of customers. In these illustrative examples, service 110 may comprise hardware, software, or a combination of the two. Configuration information 116 for location 114 may include information about the configuration of resources used in the deployment and execution of service 110 in location 114.

In these illustrative examples, categories of deployment complexity 118 in data processing system 102 are a set of categories of complexity. For example, category of deployment complexity 120 in categories of deployment complexity 118 may include one of application complexity, platform complexity, network topology complexity, authentication complexity, internationalization complexity, operational model complexity, service management model complexity, and any other complexity suitable for evaluating service deployment readiness. For example, network topology complexities may include issues in setting up a virtual private network, issues in setting up a proxy, such as a SOCKS Proxy, issues in setting up a client server remote desktop, and any other suitable network topology complexities associated with evaluating readiness of service 110 for deployment for location 114. As another example, operational model complexities may include business and technical operations issues such as customer specific preferences for particular types of resources to be used by service 110 and expectations for performance of service 110. In these illustrative examples, internationalization complexities may include identification of a list of language translations required for use by the service, subject matter experts, and customer focal points, as well as other internationalization support requirements suitable for identifying internationalization complexities associated with evaluating readiness of service 110 for deployment for location 114

As depicted, each category of deployment complexity 120 in categories of deployment complexity 118 may include template 122, schema 124, metadata 126, questionnaire to template mapping 128, and questionnaire 130. In these illustrative examples, template 122 comprises a definition of the complexity that includes a descriptive name of the complexity, a list of resources impacted by the complexity, a set of questions useful for a questionnaire, a set of possible answers to the questions, a set of default answers to the questions, and a set of rules for automating the determination of service deployment readiness. Schema 124 may be any taxonomy suitable to provide context to the information stored in template 122, metadata 128, questions 132, and subsequent answers 134. In these illustrative examples, questionnaire 130 may include questions 132, possible answers 134, and human readable service deployment description 136. Questionnaire to template mapping 128 includes rules 138. In these illustrative examples, rules 138 define how to process metadata 126 and answers 134 in a process for automating the determination of service deployment readiness of service 110.

In these illustrative examples, service 110, configuration information 116 for each location 114 in locations for service deployment 112, as well as template 122, schema 124, metadata 126, rules 138, questions 132, and subsequent answers 134 for each category of deployment complexity 120 in categories of deployment complexity 118 may be stored in data processing system 102 and retrieved by data processing system 102 for use in evaluating the service deployment readiness of service 110.

As depicted, analytics module 140, planning module 142, and questionnaire response processing module 144 in data processing system 102 are utilized to generate, retrieve, and process data in data processing system 102, in the processes described herein, for determining readiness for deploying service 110 in locations for service deployment 112. In these illustrative examples, analytics module 140 identifies metadata 126 that is associated deploying service 110 in location 114. For example, metadata 126 may include pre-defined information about resources required by service 110, information identified by analytics module 140 about resources available for use in location 114, and pre-defined customer preferences for performance and resource utilization.

Planning module 142 processes information retrieved by analytics module 140 using rules from template 122 to automatically determine tasks that need to be completed for determining the service deployment readiness of service 110 and for deploying service 110 in locations for service deployment 112. For example, when schema 124 is used in combination with template 122, rules 138, metadata 126, and answers 134, planning module 142 may be used to make automated logical determinations regarding assignment of tasks for determining readiness for deploying service 110 in locations for service deployment 112.

In these illustrative examples, questionnaire response processing module 144 uses answers 134 to identify additional requirements and additional categories of deployment complexity 118. For example, when schema 124 is used in combination with template 122, rules 138, metadata 126, and answers 134, questionnaire response processing module 144 can be used to make automated logical determinations regarding how to identify additional requirements and identify additional categories of deployment complexity 118.

In these illustrative examples, service deployment requirements 146 is a set of requirements that must be addressed for deploying and executing service 110 in locations for service deployment 112. Further in these illustrative examples, service deployment requirements 146 may be identified as associated with one or more categories of deployment complexity in categories of complexity 118. In particular service deployment requirements 146 may be identified by experts 106, by crowd sourced experts 108, and by planning module 142, in these illustrative examples.

As depicted task assignments 148 is a set of assignments in data processing system 102 for addressing the requirements that must be addressed for deploying and executing service 110 in locations for service deployment 112. Questionnaire assignments 150, as used herein, is a set of assignments in data processing system 102 for answering questionnaires, such as questionnaire 130 in category of deployment complexity 120.

The illustration of service deployment readiness evaluation environment 100 in FIG. 1 is not meant to imply physical or architectural limitations to the manner in which an illustrative embodiment may be implemented. Other components in addition to and/or in place of the ones illustrated may be used. Some components may be unnecessary. Also, the blocks are presented to illustrate some functional components. One or more of these functional components may be combined, divided, or combined and divided into different blocks when implementing an illustrative embodiment.

For example data processing system 102 may be a local area network (LAN), a wide area network (WAN), an intranet, the Internet, or some combination thereof. As another illustrative example, categories of deployment complexity 118 may be located on another computer other than data processing system 102 such as web page being viewed by a web browser.

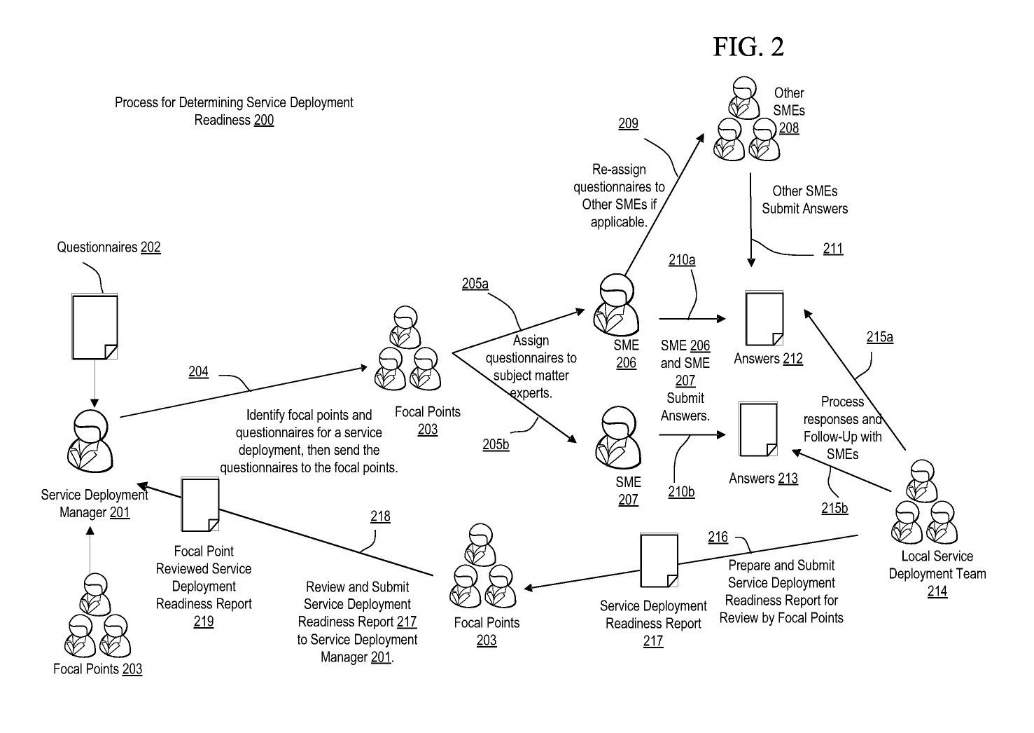

Turning next to FIG. 2, an illustrative example of a process for determining service deployment readiness is depicted in accordance with an illustrative embodiment. The steps in FIG. 2 may be implemented in service deployment readiness evaluation environment 100 in FIG. 1. In particular, the steps may be implemented in software, hardware, or a combination of the two using analytics module 140, planning module 142, and questionnaire response processing module 144 in data processing system 102 in FIG. 1.

As depicted, FIG. 2 shows a process for performing a number of steps which determine deployment readiness for a service deployment. Service deployment manager 201 identifies questionnaires 202 for use in determining service deployment readiness. Service deployment manager 201 also identifies focal points 203 for the evaluation of service deployment readiness. Service deployment manager 201 assigns responsibility for answering questionnaires 202 to identified focal points 203. Service deployment manager 201 uses link 204 to send identified questionnaires 202 to identified focal points 203. Focal points 203 determine subject matter experts, such as SME 206 and SME 207, to provide answers to the questions in one or more questionnaires in questionnaires 202. Focal points 203 then use links 205a and 205b to send to the assigned one or more questionnaires to the respectively assigned subject matter experts. In this illustrative example, SME 206 subsequently re-assigns one or more questionnaires to other subject matter experts such as other SMEs 208. Responsive to completing at least a portion of a questionnaire, SME 206, SME 207, and other SMEs 208 subsequently submit answers 212 and answers 213 which are stored for later use by local service deployment team 214.

FIG. 2 further shows local service deployment team 214 processing the responses from the subject matter experts and sending any follow-up questions to the SMEs that may arise based on the answers provided. As depicted, local service deployment team 214 prepares service deployment readiness report 217 using answers 212 and 213. Service deployment team 214 then sends prepared service deployment readiness report 217 to identified focal points 203 using link 216. Focal points 203 review and comment on service deployment readiness report 217 to form reviewed service deployment readiness report 219. Focal points 203 then send reviewed service deployment readiness report 219 to service deployment manager 201 using link 218.

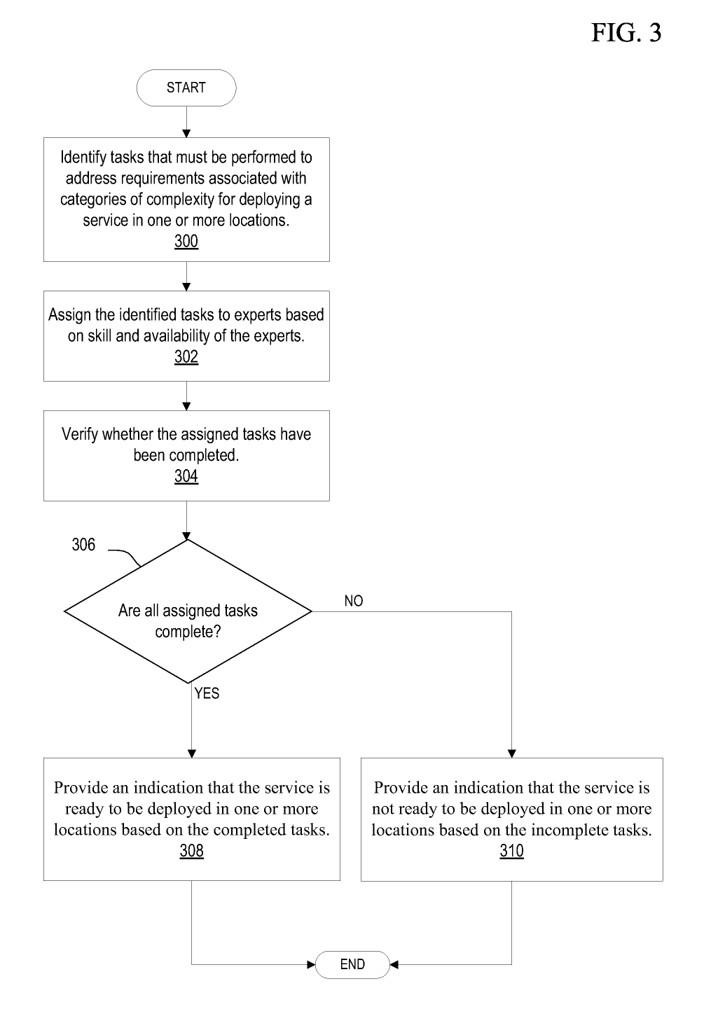

With reference now to FIG. 3, an illustrative example of a flowchart of a process for determining service deployment readiness is depicted in accordance with an illustrative embodiment. The steps in FIG. 3 may be implemented in service deployment readiness evaluation environment 100 in FIG. 1. In particular, the steps may be implemented in software, hardware, or a combination of the two using analytics module 140, planning module 142, and questionnaire response processing module 140 in data processing system 102 in FIG. 1.

The process begins by identifying tasks that must be performed to address requirements associated with categories of complexity for deploying a service in one or more locations (step 300). For example, the service may be an identify management service or any other service suitable for deployment in the one or more locations. Examples of tasks associated with deployment of a service in a location may include ensuring that all users have a client; ensuring that required internationalization support, such as translations, are available; ensuring that the has been tested to run on resources in the location under a set of pre-defined customer rules governing the deployment and execution of the service; and any other task suitable for addressing requirements associated with the categories of complexity for deploying the service in one or more locations. In these illustrative examples, the set of pre-defined rules for governing the deployment and execution of the service may include a rule for prioritizing requirements, a rule for assigning tasks according to the prioritization of the requirements that are associated with each task, and any other rule suitable for governing the deployment and execution of a service in one or more locations. The process assigns the identified tasks to experts based on skill and availability of the experts (step 302). The process then verifies whether the assigned tasks have been completed (step 304). In step 306, if all assigned tasks are complete the process continues to the next step which provides an indication that the service is ready to be deployed in one or more locations based on the completed tasks (step 308). Otherwise, if all assigned tasks are not complete the process provides an indication that the service is not ready to be deployed in one or more locations based on the incomplete tasks (step 310) with the process terminating thereafter.

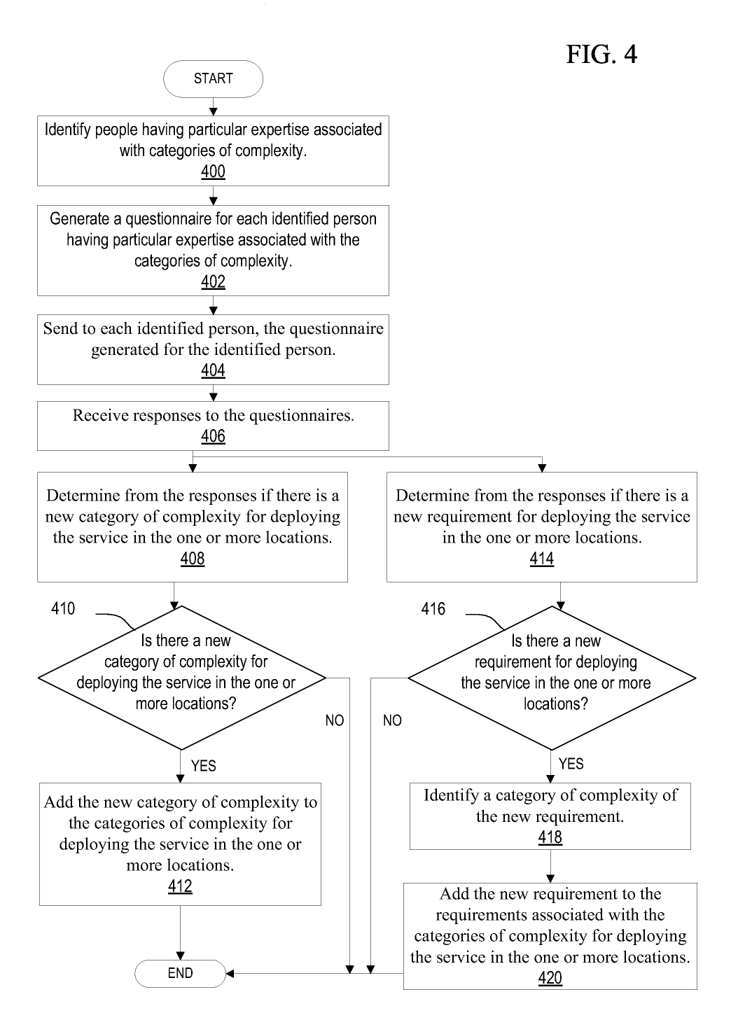

With reference now to FIG. 4, an illustrative example of a flowchart of a process for identifying categories of complexity and requirements associated with the categories of complexity for determining service deployment readiness is depicted in accordance with an illustrative embodiment. The steps in FIG. 4 may be implemented in service deployment readiness evaluation environment 100 in FIG. 1. In particular, the steps may be implemented in software, hardware, or a combination of the two using analytics module 140, planning module 142, and questionnaire response processing module 140 in data processing system 102 in FIG. 1.

The process begins by identifying people having particular expertise associated with categories of complexity for deploying a service in one or more locations (step 400). The process then generates a questionnaire for each identified person having particular expertise associated with the categories of complexity (step 402). In these illustrative examples, the questionnaire generated for a particular identified person may be a questionnaire that is filtered to only include information associated with the particular expertise of the identified person. Filtering the information in the generated questionnaire ensures that the identified person focuses only on the complexities for which the identified person has particular expertise. Alternatively, the questionnaire generated for each identified person may be a questionnaire that is not filtered and instead includes all of the information associated with the categories of complexity. Including all of the information associated with the categories of complexity, by not filtering the information, allows each identified person to see all of the information associated with the categories of complexity for the deployment of the service in the one or more locations. The process subsequently sends to each identified person, the questionnaire generated for the identified person (step 404). The process then receives responses to the questionnaires (step 406).

In response to receiving the responses to the questionnaires, a first sequence of steps of the process determines from the responses if there is a new category of complexity for deploying the service in the one or more locations (step 408). In step 410, if there is a new category of complexity for deploying the service in the one or more locations, the process continues on to step 412 where the process adds the new category of complexity to the categories of complexity for deploying the service in the one or more locations (step 412) with the first sequence of steps of the process terminating thereafter.

Additionally, in response to receiving the responses to the questionnaires, a second sequence of steps of the process determines from the responses if there is a new requirement for deploying the service in the one or more locations (step 414). In these illustrative examples, an example of a new requirement may include the identification of a previously un-identified custom application in the one or more locations or any other suitable new requirement. In this example, the custom application may require the assignment of an additional task before the service can be deployed successfully in the one or more locations. The additional task may include, for example, adding a profile for the custom application to a list of profiles of an identity management service to enable the custom application access to the identity management service. In step 416, if there is a new requirement for deploying the service in the one or more locations the process continues on to step 418 where the process identifies a category of complexity of the new requirement (step 418). The process then adds the new requirement to the requirements associated with the categories of complexity for deploying the service in the one or more locations (step 420) with the second sequence of steps of the process terminating thereafter.

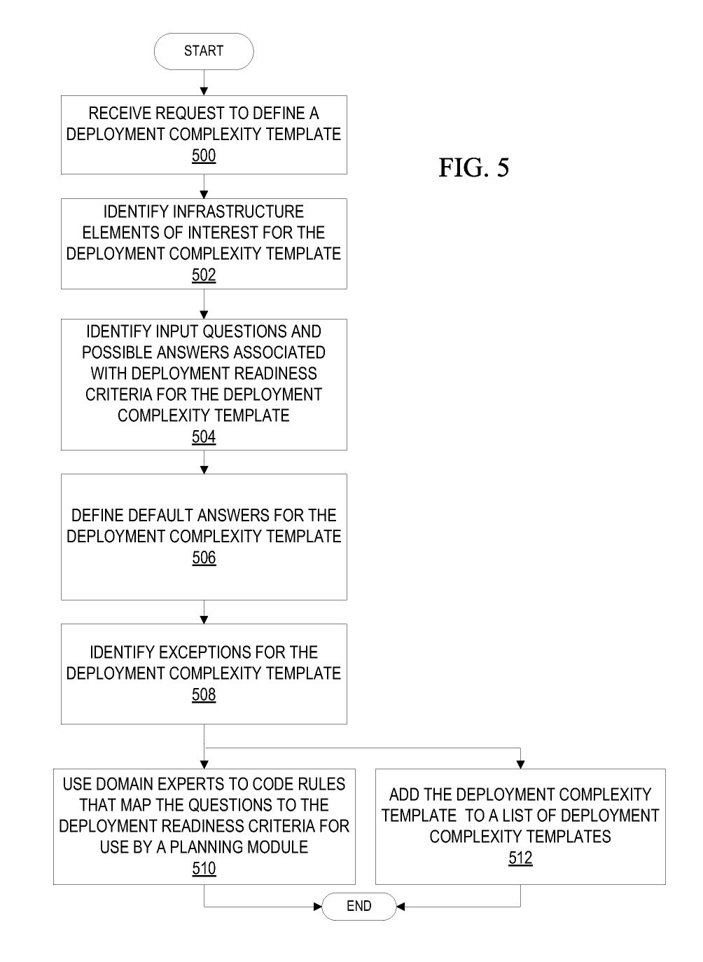

With reference now to FIG. 5, an illustrative example of a flowchart of a process for defining deployment complexity templates for use in determining service deployment readiness is depicted in accordance with an illustrative embodiment. The steps in FIG. 5 may be implemented in service deployment readiness evaluation environment 100 in FIG. 1. In particular, the steps may be implemented in software, hardware, or a combination of the two using analytics module 140, planning module 142, and questionnaire response processing module 140 in data processing system 102 in FIG. 1.

The process begins by receiving a request to define a deployment complexity template (step 500). The process identifies infrastructure elements of interest for the deployment complexity template (step 502). The process also identifies input questions and possible answers associated with deployment readiness criteria for the deployment complexity template (step 504). The process defines default answers for the deployment complexity template (step 506). The process further identifies exceptions for the deployment complexity template (step 508). The process proceeds by using domain experts to code rules that map the questions to the deployment readiness criteria for use by a planning module (step 510). The process also proceeds by adding the deployment complexity template to a list of deployment complexity templates (step 512) with the process terminating thereafter.

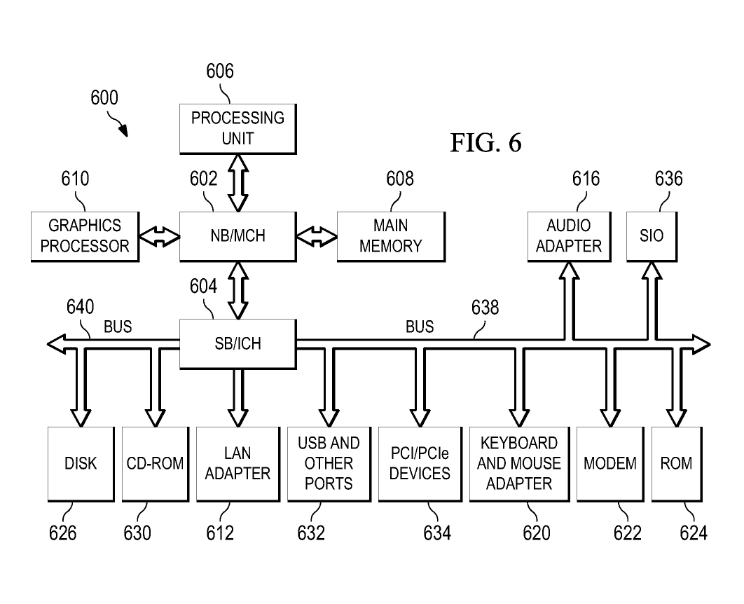

Referring to FIG. 6, a block diagram of a computer or data processing system is shown in which aspects of the present invention may be implemented. This system is an example of a computer which may be used to implement components of FIG. 1, such as analytics module 140, planning module 142, questionnaire response processing module 144, data processing system 102, and registry of service deployment experts 104, and in which computer usable code or instructions implementing the processes for embodiments of the present invention may be located.

In the depicted example, the data processing system of FIG. 6 employs a hub architecture including north bridge and memory controller hub (NB/MCH) 602 and south bridge and input/output (I/O) controller hub (SB/ICH) 604. Processing unit 606, main memory 608, and graphics processor 610 are connected to NB/MCH 602. Graphics processor 610 may be connected to NB/MCH 602 through an accelerated graphics port (AGP).

In the depicted example, local area network (LAN) adapter 612 connects to SB/ICH 604. Audio adapter 616, keyboard and mouse adapter 620, modem 622, read only memory (ROM) 624, disk 626, CD-ROM 630, universal serial bus (USB) ports and other communication ports 632, and PCl/PCIe devices 634 connect to SB/ICH 604 through bus 638 and bus 640. PCl/PCIe devices 634 may include, for example, Ethernet adapters, add-in cards, and PC cards for notebook computers. PCI uses a card bus controller, while PCIe does not. ROM 624 may be, for example, a flash binary input/output system (BIOS).

Disk 626 and CD-ROM 630 connect to SB/ICH 604 through bus 640. Disk 626 and CD-ROM 630 may use, for example, an integrated drive electronics (IDE) or serial advanced technology attachment (SATA) interface. Super I/O (SIO) device 636 may be connected to SB/ICH 604.

An operating system runs on processing unit 606 and coordinates and provides control of various components within the data processing system of FIG. 6. As a client, the operating system may be a commercially available operating system such as Microsoft® Windows® (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on the data processing system (Java is a trademark of Sun Microsystems, Inc. in the United States, other countries, or both).

As a server, the data processing system of FIG. 6 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). The data processing system may be a symmetric multiprocessor (SMP) system including a plurality of processors in processing unit 606. Alternatively, a single processor system may be employed.

Instructions for the operating system, the object-oriented programming system, and applications or programs are located on storage devices, such as disk 626, and may be loaded into main memory 608 for execution by processing unit 606. The processes for embodiments of the present invention are performed by processing unit 606 using computer usable program code, which may be located in a memory such as, for example, main memory 608, ROM 624, or in one or more peripheral devices, such as, for example, disk 626 and CD-ROM 630.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Thus, illustrative embodiments of the present invention provide a computer implemented method, data processing system, and computer program product for determining deployment readiness of a service.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for determining deployment readiness of a service, the method comprising:
a computer identifying tasks that must be performed to address requirements associated with categories of deployment complexity used in evaluating service deployment readiness for deploying a service in one or more locations, wherein the requirements are defined using a set of rules, to map questions to a deployment readiness criteria, defined by a collective intelligence of subject matter experts, comprising one or more experts and one or more crowd sourced experts;
the computer assigning the identified tasks to the subject matter experts based on skill and availability of the subject matter experts;
the computer verifying, using the rules, whether the assigned tasks have been completed; and
responsive to the verification that the tasks have been completed, the computer providing an indication that the service is ready to be deployed in one or more locations.

2. The method of claim 1, further comprising:
the computer identifying the subject matter experts having particular expertise associated with the categories of deployment complexity used in evaluating service deployment readiness;
generating, by the computer, a questionnaire for each identified one of the subject matter experts having particular expertise associated with the categories of deployment complexity used in evaluating service deployment readiness, the questionnaire comprising a description of the service, a description of the location, a description of the categories of complexity, and a description of the requirements associated with the categories of deployment complexity used in evaluating service deployment readiness; and
the computer sending to each identified one of the subject matter experts, the questionnaire generated for the identified respective one of the subject matter experts.

3. The method of claim 2, further comprising:
the computer receiving responses to the questionnaires;
the computer determining from the responses if there is a new category of deployment complexity used in evaluating service deployment readiness for deploying the service in the one or more locations; and
adding, by the computer, the new category of deployment complexity used in evaluating service deployment readiness to the categories of deployment complexity used in evaluating service deployment readiness for deploying the service in the one or more locations.

4. The method of claim 3, further comprising:
the computer determining from the responses if there is a new requirement for deploying the service in the one or more locations;
identifying, by the computer, a category of deployment complexity used in evaluating service deployment readiness of the new requirement; and
adding, by the computer, the new requirement to the requirements associated with the categories of deployment complexity used in evaluating service deployment readiness for deploying the service in one or more locations.

5. The method of claim 1, wherein the one or more locations includes a service center and the service includes a program module for deployment into the service center to be executed in the service center.

6. The method of claim 5, wherein the one or more locations includes a client computer and the service includes a second program module for deployment into the client computer to be executed in the client computer, the second program module comprising program instructions that interact with the first program module as a client of the first program module.

7. The method of claim 1, wherein the categories of deployment complexity used in evaluating service deployment readiness for deploying the service include one of application complexity, platform complexity, network topology complexity, authentication complexity, internationalization complexity, operational model complexity, and service management model complexity.

8. The method of claim 1, wherein the computer assigning the identified tasks to the subject matter experts based on skill and availability of the subject matter experts comprises using crowdsourcing to identify the subject matter experts, and wherein the computer verifying if the assigned tasks have been completed comprises using crowdsourcing to perform the verification.

9. The method of claim 2, wherein the computer identifying people having particular subject matter expertise associated with the categories of complexity comprises using crowdsourcing to identify the subject matter experts having the particular expertise.

10. The method of claim 3, wherein the computer determining if there is a new category of deployment complexity used in evaluating service deployment readiness for deploying the service in the one or more locations from the responses is performed using crowdsourcing to determine new categories of deployment complexity using the responses.

11. The method of claim 4, wherein the computer determining if there is a new requirement for deploying the service in the one or more locations from the responses is performed using crowdsourcing to determine new requirements from the responses.

12. The method of claim 1, wherein the identifying, assigning, verifying, and providing steps in claim 1 are performed according to pre-defined templates for the categories of deployment complexity, the pre-defined templates including rules for governing the processing of each step, the rules for governing the processing of each step including a rule for prioritizing the requirements and a rule for assigning tasks according to the prioritization of the requirements associated with each task.

13. A data processing system comprising:
a processor unit, a memory, and a computer readable storage device;
first program code to identify tasks that must be performed to address requirements associated with categories of deployment complexity used in evaluating service deployment readiness for deploying a service in one or more locations, wherein the requirements are defined using a set of rules, to map questions to a deployment readiness criteria, defined by a collective intelligence of subject matter experts, comprising one or more experts and one or more crowd sourced experts;
second program code to assign the identified tasks to the subject matter experts based on skill and availability of the subject matter experts;
third program code to verify, using the rules, whether the assigned tasks have been completed; and
fourth program code to provide an indication that the service is ready to be deployed in one or more locations responsive to the verification that the tasks have been completed, wherein the first program code, the second program code, the third program code, and the fourth program code are stored in the computer readable storage device for execution by the processor unit via the memory.

14. The data processing system of claim 13, further comprising:
fifth program code to identify the subject matter experts having particular expertise associated with the categories of deployment complexity used in evaluating service deployment readiness;
sixth program code to generate a questionnaire for each identified one of the subject matter experts having particular expertise associated with the categories of deployment complexity used in evaluating service deployment readiness, the questionnaire comprising a description of the service, a description of the location, a description of the categories of complexity, and a description of the requirements associated with the categories of deployment complexity used in evaluating service deployment readiness; and
seventh program code to send to each identified one of the subject matter experts, the questionnaire generated for the identified respective one of the subject matter experts, wherein the fifth program code, the sixth program code, and the seventh program code are stored in the computer readable storage device for execution by the processor unit via the memory.

15. The data processing system of claim 14, further comprising:
eighth program code to receive responses to the questionnaires;
ninth program code to determine from the responses if there is a new category of deployment complexity used in evaluating service deployment readiness for deploying the service in the one or more locations; and
tenth program code to add the new category of deployment complexity used in evaluating service deployment readiness to the categories of deployment complexity used in evaluating service deployment readiness for deploying the service in the one or more locations, wherein the eighth program code, the ninth program code, and the tenth program code are stored in the computer readable storage device for execution by the processor unit via the memory.

16. The data processing system of claim 15, further comprising:
fifth program code to determine from the responses if there is a new requirement for deploying the service in the one or more locations;
sixth program code to identify a category of deployment complexity used in evaluating service deployment readiness of the new requirement; and
seventh program code to add the new requirement to the requirements associated with the categories of deployment complexity used in evaluating service deployment readiness for deploying the service in one or more locations, wherein the fifth program code, the sixth program code, and the seventh program code are stored in the computer-readable, tangible storage device for execution by the processor unit via the memory.

17. A computer program product for determining deployment readiness of a service, the computer program product comprising:
a computer readable storage device;
program code, stored on the computer readable storage device, for identifying tasks that must be performed to address requirements associated with categories of deployment complexity used in evaluating service deployment readiness for deploying a service in one or more locations, wherein the requirements are defined using a set of rules, to map questions to a deployment readiness criteria, defined by a collective intelligence of subject matter experts, comprising one or more experts and one or more crowd sourced experts;
program code, stored on the computer readable storage device, for assigning the identified tasks to the subject matter experts based on skill and availability of the subject matter experts;
program code, stored on the computer readable storage device, for verifying, using the rules, whether the assigned tasks have been completed; and
program code, stored on the computer readable storage device, for providing an indication that the service is ready to be deployed in one or more locations responsive to the verification that the tasks have been completed.

18. The computer program product of claim 17, further comprising:
program code, stored on the computer readable storage device, for identifying the subject matter experts having particular expertise associated with the categories of deployment complexity used in evaluating service deployment readiness;
program code, stored on the computer readable storage device, for generating a questionnaire for each identified one of the subject matter experts having particular expertise associated with the categories of deployment complexity used in evaluating service deployment readiness, the questionnaire comprising a description of the service, a description of the location, a description of the categories of complexity, and a description of the requirements associated with the categories of deployment complexity used in evaluating service deployment readiness; and
program code, stored on the computer readable storage device, for sending to each one of the subject matter experts, the questionnaire generated for the identified respective one of the subject matter experts.

19. The computer program product of claim 18, further comprising:
program code, stored on the computer readable storage device, for receiving responses to the questionnaires;
program code, stored on the computer readable storage device, for determining from the responses if there is a new category of deployment complexity used in evaluating service deployment readiness for deploying the service in the one or more locations; and
program code, stored on the computer readable storage device, for adding the new category of deployment complexity used in evaluating service deployment readiness to the categories of deployment complexity used in evaluating service deployment readiness for deploying the service in the one or more locations.

20. The computer program product of claim 19, further comprising:
program code, stored on the computer readable storage device, for determining from the responses if there is a new requirement for deploying the service in the one or more locations;
program code, stored on the computer readable storage device, for identifying a category of deployment complexity used in evaluating service deployment readiness of the new requirement; and
program code, stored on the computer readable storage device, for adding the new requirement to the requirements associated with the categories of deployment complexity used in evaluating service deployment readiness for deploying the service in one or more locations.
